(19) United States
(12) Patent Application Publication
(10) Pub. No.: US 2026/0111308 A1
(43) Pub. Date: Apr. 23, 2026

(54) Buffer for Error Correction in Memory Systems

(71) Applicant: Advanced Micro Devices, Inc., Santa Clara, CA (US)

(72) Inventors: Aaron John Nygren, Boise, ID (US); Christopher Edward Cox, Placerville, CA (US); Edoardo Prete, Arlington, MA (US); Anwar Parvez Kashem, Sudbury, MA (US)

(73) Assignee: Advanced Micro Devices, Inc., Santa Clara, CA (US)

(21) Appl. No.: 19/243,984

(22) Filed: Jun. 20, 2025

Related U.S. Application Data
(60) Provisional application No. 63/709,942, filed on Oct. 21, 2024.

(51) Int. Cl. G06F 11/10

(52) U.S. Cl. CPC G06F 11/1044

(57) ABSTRACT

A buffer for error correction in memory modules is described. In one or more implementations, a memory module (e.g., a DIMM) configured for error correction code (ECC) includes a plurality of memory chips, wherein at least one memory chip includes memory die split between a first memory subchannel and a second memory subchannel. The memory module also includes a plurality of registered clock drivers (RCDs), wherein at least one RCD is configured to handle input addresses for both the first memory subchannel and the second memory subchannel. This configuration allows for efficient use of memory resources and flexibility in memory addressing, particularly for scenarios requiring ECC functionality or when dealing with memory chips of different capacities.

### RELATED APPLICATION

This application claims priority to U.S. Provisional Application Ser. No. 63/709,942, filed 21 Oct. 2024, titled “Buffer for Error Correction in Memory Modules,” the disclosure of which is incorporated by reference herein in its entirety.

### BACKGROUND

Dual In-Line Memory Modules (DIMMs) are circuit boards that hold dynamic random-access memory (DRAM) chips, which serve as the memory for many computers. Over time, advancements in DIMM technology (e.g., DDR4 to DDR5)—such as increases in speed, higher data transfer rates, and larger storage capacities—have improved computer performance, enabling faster data processing, smoother multitasking, and support for memory-intensive applications like virtual machines, large-scale databases, and artificial intelligence workloads. These innovations can also contribute to energy efficiency, which reduces power consumption while delivering higher performance.

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example of a memory system.

FIG. 3 is a block diagram of a non-limiting example of pins of multiple memory die of a memory chip, such as of a stacked DRAM.

FIG. 4 is a block diagram of a non-limiting example of different configurations of memory modules (e.g., DIMMs) for handling error correction codes (ECC).

FIG. 5 depicts a procedure in an example implementation of buffer for error correction in memory systems.

### DETAILED DESCRIPTION

Support for error correction code (ECC) is important for memory systems that include DRAM because ECC helps detect and correct errors that can occur during data storage and transmission. In systems using DRAM, such as servers or high-performance computing systems, ECC helps prevent data corruption and improve overall system reliability and stability.

Conventional memory modules with onboard error correction code (ECC) typically include memory chips with ten memory die each to handle ECC requirements. However, memory manufacturers prefer to produce memory chips with numbers of die that are powers of two, such as four or eight, for manufacturing efficiency. This mismatch creates challenges in configuring memory modules to support ECC while using memory chips with preferred die counts.

To address this issue, a memory system configured for ECC includes multiple memory chips, with at least one memory chip that has memory die split between a first memory subchannel and a second memory subchannel. The memory system also includes multiple buffers, e.g., registered clock drivers (RCDs), with at least one such buffer configured to handle routing signals for accessing memory over both the first and second memory subchannels. This approach allows the use of memory chips with preferred die counts while still supporting ECC functionality.

In at least one configuration, a memory chip with four memory die allocates two die to each subchannel. Additional memory chips on the module may have eight memory die each, with all eight die allocated exclusively to a single memory subchannel. The memory system also includes connector pins, with subsets configured to route traffic for each subchannel to the appropriate buffers. One buffer may be dedicated exclusively to each memory subchannel, while a third, additional buffer handles input addresses for both memory subchannels by mapping backside connectors to the respective subchannels. This arrangement allows for efficient use of memory resources while maintaining ECC capabilities.

This approach offers several advantages over conventional systems. It allows memory manufacturers to produce chips with preferred die counts while still supporting ECC requirements. The flexible allocation of memory die between multiple subchannels also enables efficient use of memory system resources. The configurable buffer that handles multiple subchannels reduces the need for additional components, potentially lowering costs and simplifying module design. Additionally, by supporting ECC, this configuration may help improve system reliability and data integrity, which can be particularly important in applications such as servers, data centers, and high-performance computing where data accuracy is crucial.

In some aspects, the techniques described herein relate to a memory system including: a plurality of memory chips mounted to a circuit board, wherein: the plurality of memory chips are configured to store error correction code (ECC) bits for corresponding data, and at least one memory chip of the plurality of memory chips is accessible via both a first memory subchannel and a second memory subchannel, and a plurality of buffers mounted to the circuit board, wherein at least one buffer of the plurality of buffers is configured to route signals for accessing the ECC bits and the corresponding data to the at least one memory chip via both the first memory subchannel and the second memory subchannel.

In some aspects, the techniques described herein relate to a memory system, wherein the at least one memory chip includes four memory die, and wherein a first pair of the four memory die are allocated to the first memory subchannel and a second pair of the four memory die are allocated to the second memory subchannel.

In some aspects, the techniques described herein relate to a memory system, wherein: an additional memory chip of the plurality of memory chips is accessible exclusively via the first memory subchannel, and an additional buffer of the plurality of buffers is configured to route signals for accessing the ECC bits and the corresponding data to the additional memory chip via only the first memory subchannel.

In some aspects, the techniques described herein relate to a memory system, wherein: a second additional memory chip of the plurality of memory chips is accessible exclusively via the second memory subchannel, and a second additional buffer of the plurality of buffers is configured to route signals for accessing the ECC bits and the corresponding data to the second additional memory chip via only the second memory subchannel.

In some aspects, the techniques described herein relate to a memory system, wherein: the additional memory chip includes eight memory die allocated to the first memory subchannel, and the second additional memory chip includes eight memory die allocated to the second memory subchannel.

In some aspects, the techniques described herein relate to a memory system, wherein each memory chip of the plurality of memory chips includes dynamic random-access memory (DRAM).

In some aspects, the techniques described herein relate to a memory system, wherein the memory system includes a dual in-line memory module (DIMM).

In some aspects, the techniques described herein relate to a memory system, wherein the at least one buffer is configured to route at least one of command/address (CA) signals or data (DQ) signals to the at least one memory chip via both the first memory subchannel and the second memory subchannel.

In some aspects, the techniques described herein relate to a memory system, wherein each buffer of the plurality of buffers includes a registered clock driver (RCD).

In some aspects, the techniques described herein relate to a memory system, wherein the at least one buffer is configured to map input addresses of the signals to backside memory connectors of the first memory subchannel and the second memory subchannel, wherein the backside memory connectors communicably connect the at least one buffer to pins of memory die of the at least one memory chip.

In some aspects, the techniques described herein relate to a memory system, wherein the at least one buffer receives the signals only via the first memory subchannel and routes the received signals via both the first memory subchannel and the second memory subchannel based on a mapping of input addresses to backside memory connectors.

In some aspects, the techniques described herein relate to a memory system, wherein the at least one buffer receives the signals via the first memory subchannel and the second memory subchannel.

In some aspects, the techniques described herein relate to a computing system, including: a processor, and a memory system communicatively coupled to the processor, the memory system configured to service memory access requests of the processor, wherein the memory system includes: a plurality of memory chips mounted to a circuit board, wherein: the plurality of memory chips are configured to store error correction code (ECC) bits and corresponding data based on the memory access requests, and at least one memory chip of the plurality of memory chips is accessible via both a first memory subchannel and a second memory subchannel, and a plurality of buffers mounted to the circuit board, wherein at least one buffer of the plurality of buffers is configured to route signals for accessing the ECC bits and the corresponding data to the at least one memory chip via both the first memory subchannel and the second memory subchannel.

In some aspects, the techniques described herein relate to a computing system, wherein the processor is a central processing unit (CPU) or an accelerated unit.

In some aspects, the techniques described herein relate to a computing system, further including at least one additional memory system communicatively coupled to the processor, wherein the at least one additional memory system is configured to service additional memory access requests of the processor without handling ECC for the additional memory access requests.

In some aspects, the techniques described herein relate to a method including: receiving a memory access request for a memory system, the memory system including a plurality of memory chips mounted to a circuit board and at least one memory chip of the plurality of memory chips is accessible via both a first memory subchannel and a second memory subchannel, routing, by at least one buffer of a plurality of buffers mounted to the circuit board, signals for accessing error correction code (ECC) bits and corresponding data of the memory access request to the at least one memory chip via both the first memory subchannel and the second memory subchannel, and storing the ECC bits and the corresponding data in the at least one memory chip based on the routed signals.

In some aspects, the techniques described herein relate to a method, wherein the at least one memory chip includes four memory die, and wherein routing the signals includes: routing a first subset of the signals to a first pair of the four memory die via the first memory subchannel, and routing a second subset of the signals to a second pair of the four memory die via the second memory subchannel.

In some aspects, the techniques described herein relate to a method, further including routing, by an additional buffer of the plurality of buffers, signals for accessing the ECC bits and the corresponding data to an additional memory chip of the plurality of memory chips via only the first memory subchannel.

In some aspects, the techniques described herein relate to a method, further including routing, by a second additional buffer of the plurality of buffers, signals for accessing the ECC bits and the corresponding data to a second additional memory chip of the plurality of memory chips via only the second memory subchannel.

In some aspects, the techniques described herein relate to a method, wherein routing the signals includes: receiving the signals via only the first memory subchannel, and routing the received signals via both the first memory subchannel and the second memory subchannel to the at least one memory chip based on a mapping of input addresses to backside memory connectors.

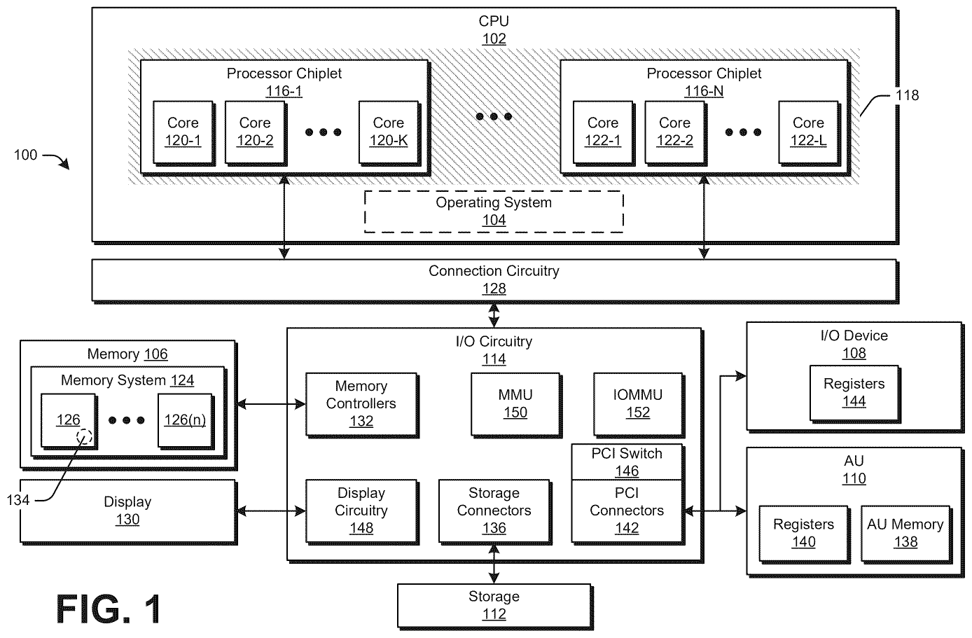

FIG. 1 is a block diagram of a processing system configured to execute one or more applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 120 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include, but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, the memory 106 is depicted with memory system 124, which is depicted with memory chips 126. In one or more implementations, the memory system 124 corresponds to a type of memory configured according to a standard, such as according to a JEDEC (Joint Electron Device Engineering Council) standard. Additionally or alternatively, the memory system 124 is a memory module, such as a dual in-line memory module (DIMM). In at least one example, for instance, the memory system 124 is a DIMM configured according to a JEDEC standard applicable to DIMMs, such as according to a double data rate #(DDR#) standard, where the ‘#’ symbol corresponds to an integer. In one or more implementations, the memory chips 126 are dynamic random-access memory (DRAM) chips, which are coupled to a printed circuit board forming the memory system 124. The memory system 124 is depicted with memory chip 126 and memory chip 126(n), where n represents any integer greater than or equal to 1. This represents that the memory system 124 is equipped with multiple memory chips 126 and may include various numbers of the memory chips 126. Although only one memory system 124 is depicted, in one or more implementations, the system 100 may include multiple memory systems 124, such as multiple memory systems 124 arranged in a stacked configuration. Additionally, or alternatively, multiple memory systems 124 arranged in a stack may also be arranged in a stack with one or more compute units, such as with one or more CPUs or GPUs and/or portions of a CPU or GPU, e.g., cores.

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106, such as by the CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, and/or any other device of the system. Examples of such requests include read requests, write requests, fetch requests, pre-fetch requests, and so on. That is to say, these memory controllers 132 are configured to manage access to the data stored at one or more memory addresses within the system memory 106, such as by CPU 102, the I/O device 108, and/or the AU 110. Although the memory controllers 132 are depicted separate from the memory system 124 in this example, in one or more implementations, one or more such memory controllers are included as part of the memory system 124, e.g., incorporated on or in or otherwise attached to the printed circuit board to which the memory chips 126 are mounted.

When an application is to be executed by processing system 100, the OS 104 running on the CPU 102 is configured to load at least a portion of program code 134 (e.g., an executable file) associated with the application from, for example, a storage 112 into system memory 106, such as into one or more memory chips 126 of the memory system 124. This storage 112, for example, includes a non-volatile storage such as a flash memory, solid-state memory, hard disk, optical disc, or the like, configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable gate arrays (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110. Alternatively, or additionally, the AU 110 includes memory like the memory system 124, e.g., one or more memory modules.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally, or alternatively, in at least one variation, the processing system 100 includes additional and/or different components from those depicted. The processing system 100 is configurable in a variety of ways with different combinations of components in accordance with the described techniques.

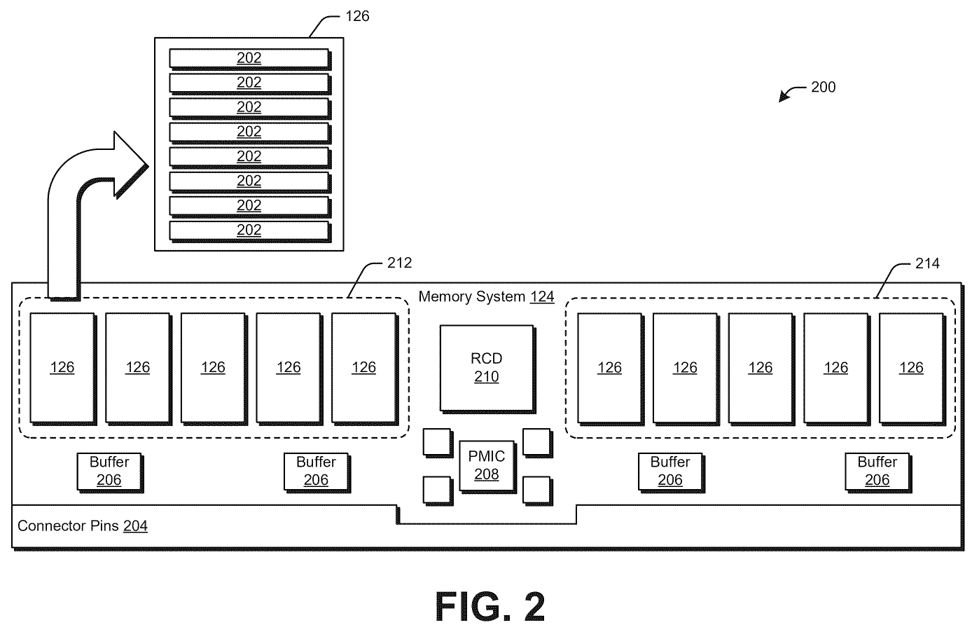

FIG. 2 is a block diagram of a non-limiting example 200 of a memory system. The illustrated example includes the memory system 124 having a plurality of the memory chips 126.

In one or more implementations, the memory system 124 is an in-line memory module, and each of the memory chips 126 is dynamic random-access memory (DRAM), such as synchronous dynamic random-access memory SDRAM. By way of example, the memory system 124 is a dual in-line memory module (DIMM). When configured as an in-line memory module, for instance, the memory system 124 includes the memory chips 126 (DRAMs) mounted communicably to a printed circuit board on one or both sides (i.e., front and/or back) of the printed circuit board. In one or more implementations, the memory system 124 is standardized, such that various aspects of the memory system 124 and/or the memory chips 126 conform to a standard, e.g., a JEDEC standard. Although ten memory chips 126 are depicted in the illustrated example, the memory system 124 can include any different integer number of memory chips 126 in accordance with the described techniques, e.g., two (2), eight (8), nine (9), twelve (12), fifteen (15), sixteen (16), twenty (20), twenty-four (24), twenty-seven (27), thirty (30), and so on.

In one or more implementations, at least one of the memory chips 126 includes a plurality of memory die 202, such as memory die arranged in a “stacked” or “3D” configuration. In connection with DRAM technology, such an arrangement may be referred to as “stacked DRAM,” “3D stacked DRAM,” or a “3D DRAM stack.” Thus, in one or more implementations, at least one of the memory chips 126 is a stacked DRAM. This also means that each of the memory chips 126 may comprise a stack of memory die 202 in at least one variation. For example, each of the memory chips 126 is a stacked DRAM. Although the view of the memory chips 126 with the stack of memory die 202 includes eight memory die, in variations, any of the memory chips 126 may have a different integer number of memory die, e.g., four (4), five (5), ten (10), and so forth, without departing from the spirit or scope of the described techniques.

The memory system 124 also includes connector pins 204. The connector pins 204 serve as electrical connectors that are used to communicably link the memory system 124 to at least one other component of a system (e.g., of the system 100), allowing transfer over the link, for example, of data, address signals, power, control signals, command/address signals, and so on, between the memory system 124 and the rest of the system. In at least one implementation, the connector pins 204 electrically connect the memory system 124 to a motherboard or “host”. The connector pins 204 can include one or more of data transfer pins, address pins, power and ground pins, control pins, and error correcting code (ECC) pins, to name just a few. The memory system 124 may include varying integer numbers of the connector pins 204 arranged in various layouts (e.g., with double rows of pins, with offset pins, with notches or cutouts in the arrangement) and having any of a variety of shapes (e.g., rectangular, triangular, rounded rectangle, etc.), without departing from the described techniques. Additionally, the connector pins 204 may be formed of any of a variety of materials including, for example, gold and/or gold plating, which is a suitable conductor of electricity and is resistant to corrosion. In variations, one or more notches or cutouts may be present in the connector pins 204, e.g., on an outboard side of the memory system 124 resulting in a gap of space (not shown) between pins and/or on an inboard side of the memory system 124 resulting in a gap (not shown) filled with at least a portion of the printed circuit board (e.g., silicon and/or other components of a printed circuit board).

In this example, the memory system 124 is also depicted with buffer(s) 206, power management integrated circuit 208 (referred to as PMIC 208), and registered clock driver 210 (referred to as RCD 210). Broadly, a registered clock driver or “RCD” is a buffer configured to buffer and re-time command, address, and/or clock signals between a host (e.g., CPU, AU, etc.) and the memory chips on the memory system, ensuring signal integrity and enabling sustained performance for various applications. For example, a buffer configured as an RCD receives such signals, holds them for a clock cycle, and then transfers the held signals to the memory chips of the memory system 124, which ensures that corresponding signals (e.g., corresponding commands and addresses) are properly buffered and retimed before reaching the memory chips. It is to be appreciated that in variations the memory system 124 includes different/additional components (e.g., one or more memory controllers), does not include one or more of the depicted and/or described components, includes different numbers of the depicted and/or described components (e.g., a different number of buffer(s) 206), and so on, without departing from the spirit or scope of the described techniques.

The buffer(s) 206 of the memory system 124 may include one or more types of buffers and/or buffers that perform any of a variety of functions for the memory system 124 (e.g., programmed to perform the different functions and/or configured in hardware to perform such different functions), such as data buffers, input buffers, output buffers, and so on. In one example, for instance, a buffer may be connected to two of the memory chips 126 on one side and to a system on chip (SoC) (e.g., the system 100) on the other side, enabling the memory chips 126 to communicate with the system in a time sequenced fashion. On a host side interface of the buffer to the system (e.g., an SoC), the buffer may effectively multiply a frequency up, doubling the bandwidth by having two devices (e.g., memory chips 126) on the other side of the buffer and supplying twice the data that is then serialized to the host (i.e., the system) at twice the speed.

In another example, a buffer may be programmed or otherwise configured to, in one direction of communication between the memory chips 126 (and/or one or more other components of the memory system 124) and one or more system components to which the memory system 124 is connected (e.g., a “host”), combine signals and/or data, and in an opposite direction of communication separate signals and/or data. For signals and/or data routed from the memory chips 126 to a host, for instance, at least one buffer(s) 206 may separate the signals and/or data for further transmission to the host. For signals and/or data routed in the opposite direction, e.g., from the host to the memory chips 126, though, the at least one buffer(s) 206 may combine the signals and/or data into one or more channels for further routing to the memory chips 126.

In one or more implementations, the memory system 124 is configured to support a multi-channel architecture, where the memory chips 126 are accessed over multiple channels of the architecture, e.g., over two or more channels. For example, a first group or cluster of the memory chips 126 is accessed over a first channel (e.g., Channel A), and a second group or cluster of the memory chips 126 is accessed over a second channel (e.g., Channel B). It is to be appreciated that the memory system 124 may support access over more than two channels, e.g., a third channel (e.g., Channel C), a fourth channel (e.g., Channel D), and so on.

While in some implementations an individual memory chip 126 is accessed over just one channel of the multiple channels (e.g., all the memory die 202 of the individual memory chip are accessed over the one channel), in variations, an individual memory chip 126 may be accessed over at least two of the multiple memory channels (e.g., a portion of the memory die 202 of the individual chip is accessed over a first channel and a different portion of the memory die 202 of the individual chip is accessed over a second channel). In at least one variation, the memory system 124 supports a combination of such access, such that a first set of the memory chips 126 (at least one memory chip) is accessed entirely by a first channel, a second set of the memory chips 126 (at least one memory chip) is accessed entirely by a second channel, and a third set of the memory chips 126 (at least one memory chip) is accessed by both the first channel and the second channel (i.e., split access). In one or more implementations, such split access may be handled by a buffer 206 that is configured to facilitate access to the appropriate memory die of the memory chips 126 with the split access, such as for memory reads and/or memory writes. One or more of the memory chips 126 may be configured for such split access in scenarios where the memory system 124 is configured for error correcting code (ECC) use, for example. It is to be appreciated that access via multiple channels to the memory chips 126 may be arranged in a variety of ways for different numbers of channels, and include, for instance, one or more memory chips 126 that are accessed entirely over just one of the multiple channels and one or more memory chips 126 that are accessed over at least two of the channels (e.g., over at least a first channel and a second channel), without departing from the described techniques.

The illustrated example is depicted with an indication of a first cluster 212 of the memory chips 126 and an indication of a second cluster 214 of the memory chips 126. In at least one implementation, the first cluster 212 of the memory chips 126 is accessed over a first channel (and via respective buffer(s) 206 and connector pins 204), and the second cluster 214 of the memory chips 126 is accessed over a second channel (and via respective buffer(s) 206 and connector pins 204). For instance, read and write accesses of the first cluster 212 of memory chips 126 are serviced over the first channel, while read and write accesses of the second cluster 214 of memory chips 126 are serviced over the second channel. In at least one variation, while the memory chips 126 are clustered into multiple clusters, the clustering may not correspond to channels over which the memory chips 126 are accessed. Instead, for instance, despite being physically clustered on a printed circuit board, each of the memory chips 126 may be accessed over multiple channels (e.g., two channels), where one or more of the memory die 202 of an individual memory chip are accessed over a first channel, and one or more other memory die 202 of that same induvial memory chip are accessed over at least one other channel.

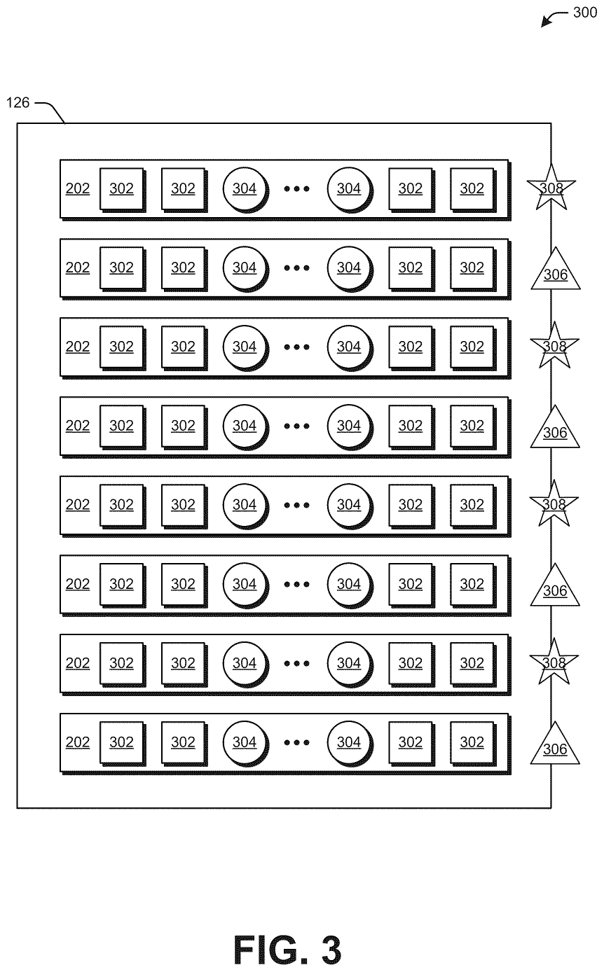

FIG. 3 is a block diagram of a non-limiting example 300 of pins of multiple memory die of a memory chip, such as of a stacked DRAM.

This figure depicts an example of one of the memory chips 126 having multiple memory die 202, such as when configured as a stacked DRAM. Here, each of the memory die 202 is shown with multiple types of pins 302, 304. As an example, the pins 302 correspond to data pins (DQ pins) and the pins 304 correspond to command/address pins (CA pins) of the memory die 202. In variations, the memory die 202 may have different numbers of pins, e.g., more pins or fewer pins. Additionally or alternatively, the memory die 202 may include different and/or additional types of pins (or pins configured for different functionality), examples of which include data strobe (DQS) pins, data mask (DM) pins, clock (CK) pins, chip select (CS) pins, and any other pin types used with DRAM.

In one or more implementations, the data (DQ) pins are bidirectional lines that transmit data during read memory accesses and write memory accesses, such as with a data strobe pin (DQS pin) acting as a strobe signal that indicates when the data on the DQ pins is valid. In other words, the data (DQ) pins are part of a memory interface, which allows data to be transferred to and from memory, such as on edges of a clock signal. As part of a DDR interface, for instance, the data (DQ) pins allow data to be transferred in connection with memory access requests (e.g., memory reads and memory writes) on both the rising and falling edges of the clock signal, doubling the effective data rate. In connection with a read memory request, the memory die 202 send data stored therein out on the data (DQ) pins, and the DQS signal indicates when the data is valid. In connection with a write memory request, a memory controller (e.g., a buffer within the memory chip 126 package or an external controller) sends data on the data (DQ) pins to be written to the memory die 202, and the DQS signal indicates when the data is valid for the memory die 202 to latch. Broadly, the data “sent” out by and/or “sent” to data (DQ) pins and the commands and addresses “sent” out by and/or “sent” to command/address (CA) pins are signals routed over physical connectors of the memory system 124, such as across a first and second memory subchannel. Signals for both data and command/address operations, are used to access ECC bits, e.g., to specify whether to read and write ECC bits and where, and to specify values for the bits to be read from and/or written to.

By way of contrast, command/address (CA) pins are electrical connections that carry commands and addresses to the memory die 202, enabling a memory controller (e.g., a buffer) to access specific memory locations and perform operations. For instance, the command/address (CA) pins allow a memory controller (e.g., a buffer) to select a memory location to access (e.g., bank, row, and/or column for DRAM) and select one or more operations to perform (e.g., read, write, etc.) at the selected memory location. Said another way, the command/address (CA) pins allow a memory controller to select a location, where data is read from or written to using the data (DQ) pins. Additionally or alternatively, the command/address (CA) pins are utilized in training procedures, such as command/address training mode, which optimizes the command/address bus for better signal stability and performance. In one or more implementations, command pins specify a type of command to perform (e.g., read, write, activate, precharge, etc.) while address pins specify the memory location, such as an address (e.g., row, column, bank).

The pins 302, 304 may be connected in a variety of ways to enable data to be read from and written to the memory die 202. In one or more implementations, the memory die 202 belong to or are otherwise associated with ranks, e.g., rank zero (R0) or rank one (R1). Broadly, the ranks define a set of DRAM memory die that are connected to a same chip select and can therefore be accessed simultaneously. The illustrated example includes a first indication 306 and a second indication 308, which may represent a first rank (rank zero—R0) and a second rank (rank one—R1), respectively. In the illustrated example, the inclusion of these ranks indicates one possible division of the memory die 202 between the different ranks. In variations, the memory die 202 may be divided differently among ranks. Alternatively or additionally, there may be a different number of ranks than two, such as one rank, three ranks, and so on.

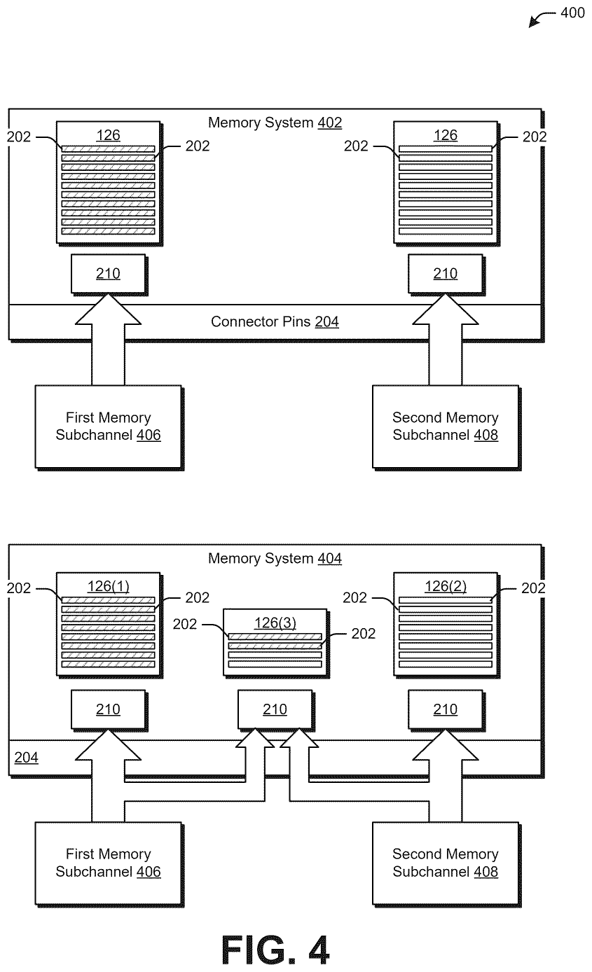

FIG. 4 is a block diagram of a non-limiting example 400 of different configurations of memory systems for handling error correction codes (ECC).

The example depicts memory system 402 and memory system 404. The memory system 402 represents a conventional configuration of a memory module for handling ECC where, for a first memory subchannel 406 and a second memory subchannel 408, the memory system 402 includes two memory chips 126, which each have ten of the memory die 202. Broadly, in a 64-bit architecture, a memory channel between a host (e.g., CPU, AU, or other SoC) and a memory system (e.g., the memory system 402 or the memory system 404) is 64 bits wide, such that the channel is configured for transferring 64 bits of data between the host and the memory system. At the memory system, this 64-bit channel is divided into two independently addressable 32-bit subchannels, e.g., subchannel A and subchannel B. Also, a first portion of memory implemented by the memory system is allocated to a first subchannel, and a second portion of the memory implemented by the memory system is allocated to a second subchannel. By splitting the memory system into two subchannels, data can be accessed from both subchannels concurrently, increasing efficiency and lowering latency. To support the algorithms which implement ECC, 8 additional bits are added to each subchannel for a total of 40 bits per subchannel or 80 bits per rank. Due to the additional ECC bits, memory systems that support onboard ECC commonly utilize ten memory die per subchannel rather than eight per subchannel. In at least one variation, though, memory systems that support onboard ECC utilize nine (9) memory die per subchannel.

With the conventional ten-die configuration of memory system 402, the first memory subchannel 406 is routed to its individual memory chip 126 having ten memory die 202 via a respective RCD 210. Similarly, the second memory subchannel 408 is routed to its individual memory chip 126 having ten memory die 202 via a respective RCD 210. One problem with such conventional configurations is that each memory chip 126 includes ten memory die 202 to support error correction coding (ECC). As noted above, however, memory manufacturers predominantly fabricate memory chips 126 (e.g., DRAM) with a die count that is a power of two, such as two, four, or eight die per chip. Thus, the requirement for a ten-die configuration deviates from the majority of memory chips manufactured, requiring additional and/or different tooling and production adjustments, which can increase manufacturing complexity and cost. Due to these factors, memory manufacturers prefer to produce memory chips that have a common number of memory die and that can be interchangeably used for any of a variety of purposes, such as for MUX mode and/or ECC mode.

By way of contrast to the memory system 402, the memory system 404 includes only memory chips 126 having numbers of memory die that are a power of two (2). For example, the memory system 404 includes two memory chips 126, memory chip 126(1) and memory chip 126(2), having eight (8) memory die 202, and a third memory chip 126, memory chip 126(3), having four memory die 202. Relative to the memory system 402, the number of individual memory die 202 on the memory system 404 is the same. However, the memory die 202 of the memory system 404 are divided among more memory chips 126, i.e., divided between three memory chips 126 rather than just two. This change in the number of memory chips 126 introduces some complexities with subchannel routing where there are two subchannels, such as where there are two command/address subchannels and/or two data channels for handling ECC. Although the memory system 404 is depicted including three (3) memory chips 126, in variations, a memory system may have different numbers of memory chips 126 without departing from the spirit or scope of the described techniques.

To enable the memory system 404 to handle ECC, each of the subchannels is allocated ten of the memory die 202. For instance, a first ten of the memory die 202 of the memory system 404 are allocated to the first memory subchannel 406, and a second ten of the memory die 202 of the memory system 404 are allocated to the second memory subchannel 408. To accomplish this, in one or more implementations, the memory die 202 of at least one of the memory chips 126 of the memory system 404 is split between the two subchannels. In this example, for instance, the memory die 202 of the memory chip 126(3) are split between the two subchannels, such that two of the memory die 202 are allocated to the first memory subchannel 406 and the other two memory die 202 are allocated to the second memory subchannel 408. Although command/address subchannels are discussed throughout, in at least one variation, the described techniques are applicable to additional and/or alternative subchannels, such as subchannels for data (DQ) inputs and/or for other inputs.

To handle the additional memory chip 126(3), which has the memory die 202 split between the two different subchannels, the memory system 404 also includes an additional RCD 210 (e.g., a third buffer configured as an RCD) relative to the memory system 402. This additional RCD 210 is configured to handle two sets of input addresses (e.g., input addresses for the first memory subchannel 406 and also input addresses for the second memory subchannel 408) through a mapping of the backside command/address connectors to the memory die and/or pins of the two subchannels. Although the illustrated example depicts using registered clock drivers, in at least one variation, other types of buffers may be used to route signals to the memory chips 126 in such a split fashion to implement ECC.

In one or more implementations, the manner in which the additional RCD operates contrasts with how the other RCDs, which exclusively serve a respective memory chip (i.e., the memory chip 126(1) or the memory chip 126(2)) operate. For instance, the RCDs 210 which exclusively serve a respective memory chip 126 are configured to each only handle one set of input addresses, which map the backside command/address connectors for an individual subchannel. While those RCDs are configured and utilized to exclusively serve just one of the memory chips, the hardware used to implement those RCDs can be the same as the hardware utilized for the additional RCD, but programmed or configured in a different manner. In other words, a same hardware component (e.g., RCD or buffer) may be configurable (e.g., programmable) to exclusively handle one set of input addresses for ECC or to handle two sets of input addresses for ECC. In the depicted example 400, the RCD 210 depicted on the left of the memory system 404 is utilized to handle only the input addresses for the first memory subchannel 406 and to map them to the memory chip 126(1). The RCD 210 depicted on the right of the memory system 404 is utilized to handle only the input addresses for the second memory subchannel 408 and to map them to the memory chip 126(2).

In at least one variation, the additional RCD is configured to receive command/address (CA) and/or data (DQ) inputs from a first subchannel and then communicate to both the first subchannel and a second subchannel on the backside. In such variations, the additional RCD may translate or otherwise allocate a subset of inputs received over the first subchannel to communicate them over the second subchannel on the backside, e.g., between the RCD and the memory chips. Alternatively or additionally, the additional RCD is configured to receive command/address (CA) and/or data (DQ) inputs from more than one subchannel and communicate with the multiple subchannels on the backside. Alternatively or additionally, an RCD is programmable “in the field” to be capable of either of or both of these functionalities and/or is configurable or reconfigurable via external pins, registers, and so forth.

To accomplish frontside routing, e.g., routing between a system on chip (SoC) and the RCDs 210, a first subset of the connector pins 204 is configured (e.g., suitably connected) to route traffic for the first memory subchannel 406 to both the left and center RCD 210, and a second subset of the connector pins 204 is configured (e.g., suitably connected) to route traffic for the second memory subchannel 408 to both the right and center RCD 210. In one or more implementations, the connector pins 204 which route traffic for the first memory subchannel 406 to the left and center RCD 210 are different connector pins from those which route traffic for the second memory subchannel 408 to the right and center RCD 210. As noted above, the RCDs 120 handle the backside routing, e.g., from the RCDs over connectors to the appropriate memory chip 126 and/or the appropriate memory die 202 of the appropriate memory chip 126.

As noted above, the memory system 404 is depicted including three (3) memory chips 126. In variations, though, a memory system configured in accordance with the described techniques may have different numbers of memory chips 126 and the memory chips may have different numbers of memory die 202 per subchannel for handling ECC than depicted. In another example where the memory system 404 includes ten memory die per subchannel to handle ECC, for instance, the memory system 404 may include five memory chips 126 (instead of the depicted three) each having four memory die, such that the four memory die of each of the first and second memory chips are allocated to the first memory subchannel 406, the four memory die of the third memory chip are split (two and two) between the first memory subchannel 406 and the second memory subchannel 408, and the four memory die of each of the fourth and fifth memory chips are allocated to the second memory subchannel 408.

In at least one variation where the memory system 404 includes nine memory die per subchannel to handle ECC, the memory system 404 may also include five memory chips 126. In such variations, though, four of the five memory chips have four memory die while a split memory chip has two memory die, one memory die per subchannel. For example, the four memory die of each of the first and second memory chip are allocated to the first memory subchannel 406, the two memory die of the third memory chip are split (one and one) between the first memory subchannel 406 and the second memory subchannel 408, and the four memory die of each of the fourth and fifth memory chip are allocated to the second memory subchannel 408.

Rather than supporting ECC with nine or ten memory die, in some implementations, a memory system supports ECC operations with five memory die per subchannel. In at least one such implementation where the memory system includes five memory die per subchannel to handle ECC, the memory system may include five memory chips each having two memory die, such that the two memory die of each of the first and second memory chips are allocated to the first memory subchannel 406, the two memory die of the third memory chip are split (one and one) between the first memory subchannel 406 and the second memory subchannel 408, and the two memory die of each of the fourth and fifth memory chips are allocated to the second memory subchannel 408.

In another example where the memory system 404 includes five memory die per subchannel to handle ECC, the memory system 404 may include three memory chips 126. In such variations, the first memory chip includes four memory die allocated to the first memory subchannel 406, the second memory chip includes two memory die split (one and one) between the first memory subchannel 406 and the second memory subchannel 408, and the third memory chip includes four memory die allocated to the second memory subchannel 408. It is to be appreciated that memory systems configured to support ECC in accordance with the described techniques may have different numbers of memory chips and different numbers of memory die than described herein, as long as the memory die of at least one of the memory chips are split between multiple different subchannels. For instance, at least a first memory die of such a memory chip is allocated to a first subchannel and at least a second memory die of such a memory chip is allocated to a second subchannel.

Error Correction Code (ECC) is a method used in memory systems to detect and correct errors that may occur during data storage and retrieval processes. ECC works by adding redundancy to the data stored in memory chips, typically through additional bits that are calculated using the original data bits. These extra bits are known as parity bits. When data is written to a memory system, ECC algorithms generate parity bits based on the data bits and store them alongside the data. Later, when the data is read back, the ECC system recalculates the parity bits to determine if any errors have occurred during storage or transmission. If the recalculated parity does not match the stored parity, the ECC system can identify and correct errors in the data, often without any intervention from the system's processor.

This capability to detect and correct errors enhances the reliability of memory systems, particularly in environments where data integrity is critical, such as in servers, data centers, and systems handling critical applications. ECC is particularly valuable in addressing single-bit errors, which are the most common type of error in memory systems.

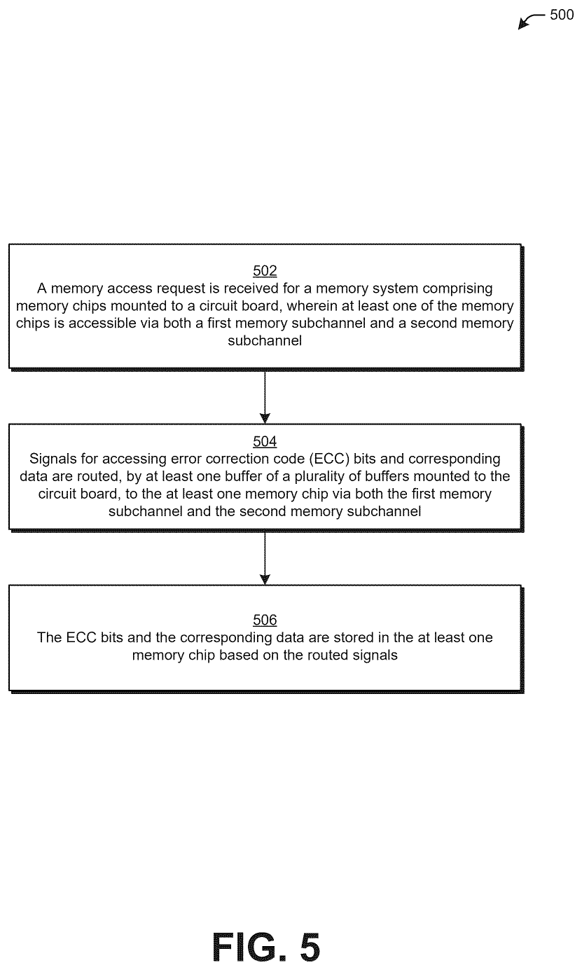

FIG. 5 depicts a procedure 500 in an example implementation of buffer for error correction in memory systems.

A memory access request is received for a memory system comprising multiple memory chips mounted to a circuit board (block 502). In accordance with the principles discussed herein, at least one of the memory chips is accessible via both a first memory subchannel and a second memory subchannel. By way of example, a memory access request is received at the memory system 404, which includes multiple memory chips 126, with at least one memory chip 126(3) having memory die 202 split for access between the first memory subchannel 406 and the second memory subchannel 408.

To service the memory access request, signals for accessing error correction code (ECC) bits and corresponding data of the memory access request are routed by at least one buffer to the at least one memory chip via both the first memory subchannel and the second memory subchannel (block 504). By way of example, the RCDs 210 of the memory system 404 route signals for accessing ECC bits and corresponding data across multiple memory chips 126. This routing can involve sending command, address, and/or data signals over the first memory subchannel 406 and the second memory subchannel 408.

In accordance with the described techniques, the RCD 210 connected to the memory chip 126(3) routes signals for accessing ECC bits and corresponding data to the memory chip 126(3) across both the first memory subchannel 406 and the second memory subchannel 408. This allows for efficient handling of ECC operations by utilizing memory die 202 split across multiple memory subchannels.

Further, an additional buffer (e.g., an additional RCD 210) of the plurality of buffers routes signals for accessing the ECC bits and the corresponding data to an additional memory chip (e.g., memory chip 126(1)) via only the first memory subchannel 406. A second additional buffer of the plurality of buffers may route signals for accessing the ECC bits and the corresponding data to a second additional memory chip (e.g., memory chip 126(2)) via only the second memory subchannel 408.

Based on the routing, the ECC bits and the corresponding data are stored in the at least one memory chip (block 506). For instance, the ECC bits and corresponding data are stored across multiple memory die 202 of the memory chip 126(3), with some data stored in memory die accessed via the first memory subchannel 406 and other data stored in memory die accessed via the second memory subchannel 408. This split storage approach may allow for efficient utilization of memory resources while maintaining ECC capabilities.

In some implementations, the routing of signals and storage of ECC bits and corresponding data may be performed concurrently across multiple memory chips 126. For example, while some ECC bits and data are being stored in the split-access memory chip 126(3), additional ECC bits and data may be simultaneously stored in memory chips 126(1) and 126(2) via their respective subchannels. This parallel processing approach may further enhance the efficiency and performance of the memory system 404 in handling ECC operations.

It is to be appreciated that the figures are not drawn to scale in the illustrated examples, and the various shapes used in the figures to represent various components may differ (perhaps significantly) from the actual shapes of those components in implementation.

What is claimed is:

1. A memory system comprising:
a plurality of memory chips mounted to a circuit board, wherein:
the plurality of memory chips are configured to store error correction code (ECC) bits for corresponding data; and
at least one memory chip of the plurality of memory chips is accessible via both a first memory subchannel and a second memory subchannel; and
a plurality of buffers mounted to the circuit board, wherein at least one buffer of the plurality of buffers is configured to route signals for accessing the ECC bits and the corresponding data to the at least one memory chip via both the first memory subchannel and the second memory subchannel.

2. The memory system of claim 1, wherein the at least one memory chip includes four memory die, and wherein a first pair of the four memory die are allocated to the first memory subchannel and a second pair of the four memory die are allocated to the second memory subchannel.

3. The memory system of claim 1, wherein:
an additional memory chip of the plurality of memory chips is accessible exclusively via the first memory subchannel; and
an additional buffer of the plurality of buffers is configured to route signals for accessing the ECC bits and the corresponding data to the additional memory chip via only the first memory subchannel.

4. The memory system of claim 3, wherein:
a second additional memory chip of the plurality of memory chips is accessible exclusively via the second memory subchannel; and
a second additional buffer of the plurality of buffers is configured to route signals for accessing the ECC bits and the corresponding data to the second additional memory chip via only the second memory subchannel.

5. The memory system of claim 4, wherein:
the additional memory chip comprises eight memory die allocated to the first memory subchannel; and
the second additional memory chip comprises eight memory die allocated to the second memory subchannel.

6. The memory system of claim 1, wherein each memory chip of the plurality of memory chips comprises dynamic random-access memory (DRAM).

7. The memory system of claim 1, wherein the memory system comprises a dual in-line memory module (DIMM).

8. The memory system of claim 1, wherein the at least one buffer is configured to route at least one of command/address (CA) signals or data (DQ) signals to the at least one memory chip via both the first memory subchannel and the second memory subchannel.

9. The memory system of claim 1, wherein each buffer of the plurality of buffers comprises a registered clock driver (RCD).

10. The memory system of claim 1, wherein the at least one buffer is configured to map input addresses of the signals to backside memory connectors of the first memory subchannel and the second memory subchannel, wherein the backside memory connectors communicably connect the at least one buffer to pins of memory die of the at least one memory chip.

11. The memory system of claim 1, wherein the at least one buffer receives the signals only via the first memory subchannel and routes the received signals via both the first memory subchannel and the second memory subchannel based on a mapping of input addresses to backside memory connectors.

12. The memory system of claim 1, wherein the at least one buffer receives the signals via the first memory subchannel and the second memory subchannel.

13. A computing system, comprising:
a processor; and
a memory system communicatively coupled to the processor, the memory system configured to service memory access requests of the processor, wherein the memory system comprises:
a plurality of memory chips mounted to a circuit board, wherein:
the plurality of memory chips are configured to store error correction code (ECC) bits and corresponding data based on the memory access requests; and
at least one memory chip of the plurality of memory chips is accessible via both a first memory subchannel and a second memory subchannel; and
a plurality of buffers mounted to the circuit board, wherein at least one buffer of the plurality of buffers is configured to route signals for accessing the ECC bits and the corresponding data to the at least one memory chip via both the first memory subchannel and the second memory subchannel.

14. The computing system of claim 13, wherein the processor is a central processing unit (CPU) or an accelerated unit.

15. The computing system of claim 13, further comprising at least one additional memory system communicatively coupled to the processor, wherein the at least one additional memory system is configured to service additional memory access requests of the processor without handling ECC for the additional memory access requests.

16. A method comprising:
receiving a memory access request for a memory system, the memory system comprising a plurality of memory chips mounted to a circuit board and at least one memory chip of the plurality of memory chips is accessible via both a first memory subchannel and a second memory subchannel;
routing, by at least one buffer of a plurality of buffers mounted to the circuit board, signals for accessing error correction code (ECC) bits and corresponding data of the memory access request to the at least one memory chip via both the first memory subchannel and the second memory subchannel; and
storing the ECC bits and the corresponding data in the at least one memory chip based on the routed signals.

17. The method of claim 16, wherein the at least one memory chip includes four memory die, and wherein routing the signals comprises:
routing a first subset of the signals to a first pair of the four memory die via the first memory subchannel; and
routing a second subset of the signals to a second pair of the four memory die via the second memory subchannel.

18. The method of claim 16, further comprising routing, by an additional buffer of the plurality of buffers, signals for accessing the ECC bits and the corresponding data to an additional memory chip of the plurality of memory chips via only the first memory subchannel.

19. The method of claim 18, further comprising routing, by a second additional buffer of the plurality of buffers, signals for accessing the ECC bits and the corresponding data to a second additional memory chip of the plurality of memory chips via only the second memory subchannel.

20. The method of claim 16, wherein routing the signals comprises:
receiving the signals via only the first memory subchannel; and
routing the received signals via both the first memory subchannel and the second memory subchannel to the at least one memory chip based on a mapping of input addresses to backside memory connectors.
